(19) United States
(12) Patent Application Publication
(10) Pub. No.: US 2006/0218428 A1
(43) Pub. Date: Sep. 28, 2006

(54) Systems and methods for operating within operating condition limits

(76) Inventor: Kevin A. Hurd, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/086,026

(22) Filed: Mar. 22, 2005

(51) Int. Cl. G06F 1/00

(52) U.S. Cl. 713/500

(57) ABSTRACT

Systems and methods for operating within operating condition limits are disclosed. One embodiment of a system may comprise a margin detector that generates a specification value that is a function of a plurality of operating factors associated with a core circuit and compares the specification value with a predetermined threshold to determine if the core circuit is operating below operating condition limits. The system may further comprise an operating condition control that adjusts an activity level of the core circuit if the core circuit is operating above operating condition limits.

### BACKGROUND

A silicon chip design (e.g., a processor) has core functionality that operates properly within certain operating limits (e.g., voltage, temperature, frequency). If a design is operating outside the allowed operating limits, the core functionality may fail. Also, the behavior of the design can have a direct influence on the operating limits. For example, an increase of the activity of the core functionality of a silicon design will increase the power drawn, which will put additional stress on the voltage and temperature control systems leading to lower voltages and higher temperatures for the core functionality, both of which degrade the operating conditions. In addition, jitter and frequency error can cause the operating frequency of the circuits of the core functionality to be higher than expected, which degrades the operating margin available to the design. Normally, external forces and age can cause the operating conditions to degrade over time resulting in an eventual failure of the silicon design.

### BRIEF DESCRIPTION OF THE DRAWINGS

FIG. 1 illustrates a block diagram of an embodiment of a system for operating within operating condition limits.

FIG. 2 illustrates a schematic block diagram of an embodiment of an oscillator.

FIG. 3 illustrates a schematic block diagram of an embodiment of a margin detector.

FIG. 4 illustrates a block diagram of a system for maintaining operating conditions below operating condition limits for a processor.

FIG. 5 illustrates an embodiment of an instruction throughput portion of a processor.

FIG. 6 illustrates an embodiment of a methodology for operating within operating condition limits.

FIG. 7 illustrates an embodiment of methodology for maintaining operating conditions within operating condition limits.

### DETAILED DESCRIPTION

This disclosure relates generally to systems and methods for operating within operating condition limits. The systems and methods monitor operating factors associated with operating conditions of an integrated circuit. The operating factors are employed to determine an aggregated operating specification value, which corresponds to the operating conditions of the integrated circuit. The aggregated specification value is compared to a predetermined threshold value to determine if the integrated circuit is operating within (below) or outside (above) the operating condition limits of the integrated circuit. If the integrated circuit is operating outside the operating condition limits, corrective action (e.g., reducing instruction throughput) is taken to adjust the operating conditions (e.g., activity level), such that the operating conditions are below the operating condition limits. The operation condition limits and the predetermined threshold value are set at an operating condition point that is below a maximum specification value associated with the maximum allowable operating conditions to maintain a margin between operating conditions and the maximum specification value in an attempt to maintain operation below the maximum allowable operating conditions.

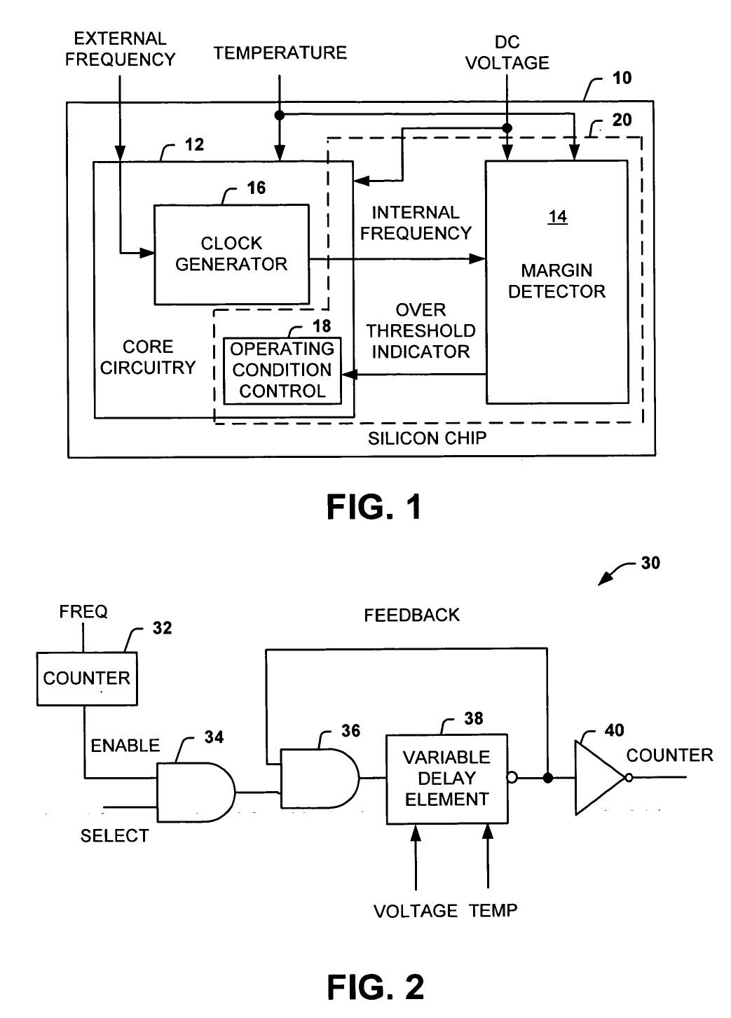

FIG. 1 illustrates an integrated circuit employing a system 20 for operating within operating condition limits. The integrated circuit 10 (e.g., a silicon chip) includes core circuitry 12 that includes the core functionality associated with the integrated circuit 10. The core circuitry 12 can be circuitry associated with, for example, a processor having an instruction control throughput portion. The core circuitry 12 also includes a clock generator 16 that generated an internal clock having an internal frequency (e.g., core frequency) derived from an external frequency (e.g., a system bus clock). The core circuitry 12 operates at a DC voltage level based on a DC voltage, and is subject to an operating temperature that is a function of a cooling system (e.g., fans, heat sinks, baffles, air flow) and the ambient temperature outside the integrated circuit 10, the power dissipation ability of the integrated circuit 10 and the activity level of the core circuitry 12. The core circuitry 12 has a maximum allowable temperature and a minimum allowable voltage in which it can operate at a given frequency. The system 20 allows the core circuitry 12 to continue to operate at a reduced performance level (e.g., frequency) if the frequency exceeds a maximum allowable frequency, the temperature exceeds the maximum allowable temperature or the voltage falls below the minimum allowable voltage. Also, a reduction in operating voltage includes a reduction in maximum allowable temperature.

The system 20 includes a margin detector 14 and an operating condition control 18 associated with the core circuitry 12. The margin detector 14 is fabricated on the same integrated circuit material (e.g., the same silicon chip), and subject to the same fabrication processes, such that the margin detector 14 has similar inherent characteristics and manufacturing variations as the core circuitry 12, which ages at the same rate as the core circuitry 12. Additionally, the margin detector 14 is subjected to the same operating temperature as the core circuitry 12, employs the same DC voltage level as the core circuitry 12 and the same internal frequency of the core circuitry 12. Therefore, the margin detector 14 encodes the voltage, frequency, temperature and age of the core circuitry 12 to generate an aggregated specification value corresponding to the operating conditions of the core circuitry 12.

The aggregated specification value is compared to a predetermined threshold value to determine if the core circuitry 12 is operating within or outside the operating condition limits of the core circuitry 12. The predetermined threshold value is set at an operating condition point that is below a maximum specification value associated with maximum allowable operating conditions of the core circuitry 12 to maintain a margin between operating conditions and the maximum specification value. If the core circuitry 12 is operating outside the operating condition limits, an overthreshold indicator is provided to the operating condition control 18. The operating condition control 18 adjusts the operating conditions (e.g., activity level) of the core circuitry 12 to reduce the operating conditions below the operating condition limits. For example, an adjustment in the activity level of the core circuitry 12 results in a reduction in power dissipation and a reduction in temperature of the core circuit.

FIG. 2 illustrates an oscillator 30 associated with a margin detector. The oscillator 30 encodes the core frequency, the core voltage and the core temperature into an encoded oscillator signal. The oscillator cycles can be counted to determine an aggregated specification value that provides an aggregated measure of the operating conditions of the core circuitry. The oscillator 30 includes a counter 32 that generates an oscillator enable line for a predetermined clock cycle count time period based the internal frequency of the core clock generator 16. For example, the oscillator enable line can be active for 65,536 clock cycles. Therefore, the oscillator will oscillate for 65,536 clock cycles associated with the internal frequency of the core circuitry. This allows the oscillator to encode the internal clock frequency of the core circuitry. The oscillator 30 includes a first AND gate 34 that receives the oscillator enable line as a first input, and an oscillator select line as a second input. The oscillator select line provides for selection of an oscillator from a plurality of oscillators, such that an oscillator that most closely matches the electrical characteristics of the core circuitry can be selected.

The oscillator 30 includes a second AND gate 36, a variable delay element 38, and an output inverter 40. The second AND gate 36 receives an output of the first AND gate 34 as a first input and a feedback signal from the output of the variable delay element 38 as a second input. The output of the variable delay element 38 is inverted such that the feedback signal to the second AND gate 36 causes the output of the variable delay element 38 to oscillate in response to the first input of the second AND gate 36 being in an active state. The variable delay element 38 includes circuitry (e.g., inverters, buffers) that operate at the core DC voltage and are subject to the core operating temperature. Therefore, the variable delay element 38 oscillates at an encoded frequency that corresponds to the core frequency, core voltage and core temperature. The variable delay element 38 is also subject to the same aging as the core circuitry. The output of the variable delay element 38 is provided to a counter through the inverter 40 to provide a count value over the predetermined clock cycle count time period that provides an aggregated measure or count corresponding to the operating conditions of the core circuitry. The count value will decrease with an increase in core frequency, an increase in core temperature or a decrease in core voltage. If the count value falls below a threshold count value, the core circuitry is exceeding its operating condition limits.

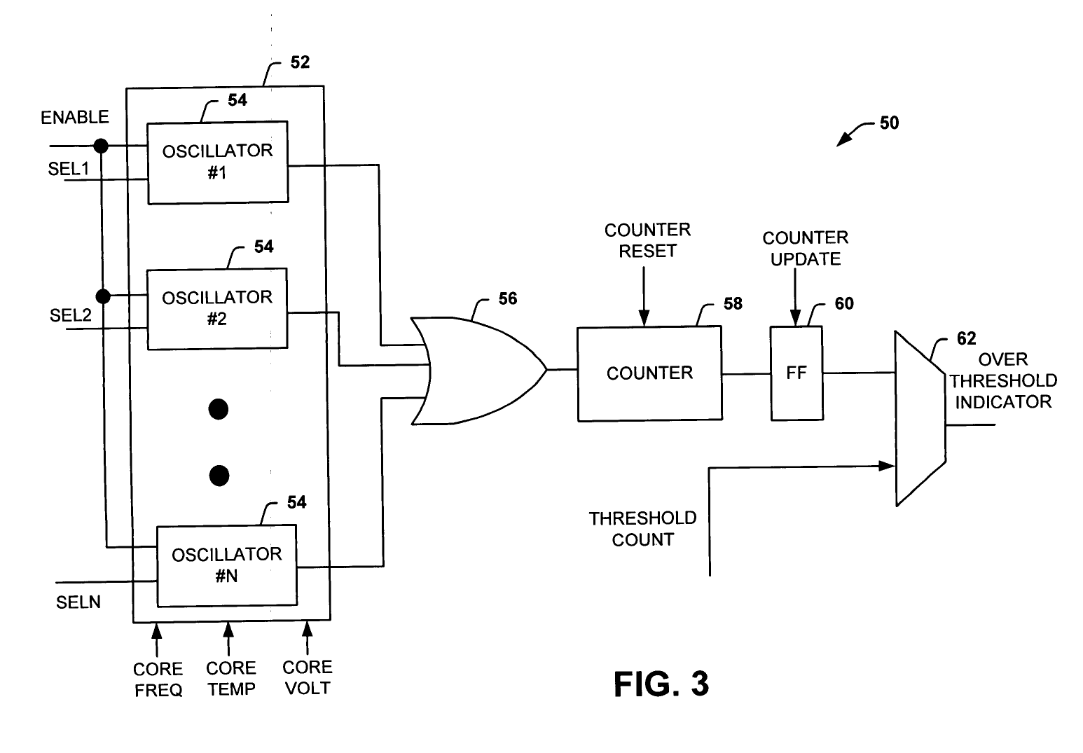

FIG. 3 illustrates an embodiment of a margin detector 50. The margin detector 50 includes an oscillator portion 52 that includes a plurality of oscillators 54, labeled oscillator #1 through oscillator #N, where N is an integer greater than or equal to one. Each oscillator 54 exhibits different characteristics that mimic a given critical path (e.g., time takes to get through gates) of the core circuitry. A variable delay element can be employed that mimics the electrical characteristics of the given critical or longest path (e.g., a given load instruction, a given store instruction) associated with the operation of the core circuitry. The variable delay element can be fabricated from transistors, transistor and wires, wire dominated or area resistor dominated elements to exhibit different delay characteristics that can correspond to characteristics of different electrical critical paths of the core circuitry. The delay element that corresponds the closest to the critical path of the core circuitry can be selected to exhibit the same electrical characteristics as the critical path of the core circuitry when subject to the same frequency, temperature and voltage as the critical path. Therefore, an oscillator 54 can be selected at test time which is representative of the electrical characteristics or the critical path of the core circuitry.

A select line (SEL1-SELN) selects a given oscillator 54 most representative of the operating characteristics or critical path of the core circuitry. An oscillator enable line is provided to the selected oscillator 54 that is active for a predetermined clock cycle count time period (e.g., 65,536 clock cycles) associated with the core clock. During the predetermined clock cycle count time period, the oscillator 54 oscillates at a frequency that corresponds to the delay of the delay element (or critical path) with the core frequency, core temperature and core voltage encoded into the oscillator frequency, as illustrated in FIG. 2. The outputs of each of the plurality of oscillators are provided as inputs to a multiple input OR gate 56. The oscillator output signal of the selected oscillator 54 is provided as an input to a high speed counter 58. The high speed counter 58 determines a count value (e.g., 40,000-100,000 counts) over the predetermined clock cycle count time period that corresponds to an aggregated measure of the operating conditions of the core circuitry.

At the end of the predetermined clock cycle time period, the count value is updated by clocking in the counter value to a comparator 62 through a flip flop 60 via a counter update signal. The counter value or aggregated specification count value is compared to a predetermined threshold count value to determine if the core circuitry is operating within or outside the operating condition limits of the core circuitry. The predetermined threshold count is indicative of the operating condition limits of the core circuitry and can be determined at manufacturing test time and set for normal operation. The predetermined threshold value and the operating condition limits are set at an operating condition point that is below a maximum specification value associated with maximum allowable operating conditions to maintain a margin between operating conditions and the maximum specification value. If the count value is below the predetermined threshold count, the core circuitry is operating outside the operating condition limits and an overthreshold indicator signal is generated. Otherwise the core circuitry is operating within the operating condition limits, and an overthreshold indicator signal is not generated. The counter 58 is then reset and the process repeats. The counter update, the comparison and the counter reset may take several clock cycles, but can be relatively small compared to the predetermined clock cycle time period.

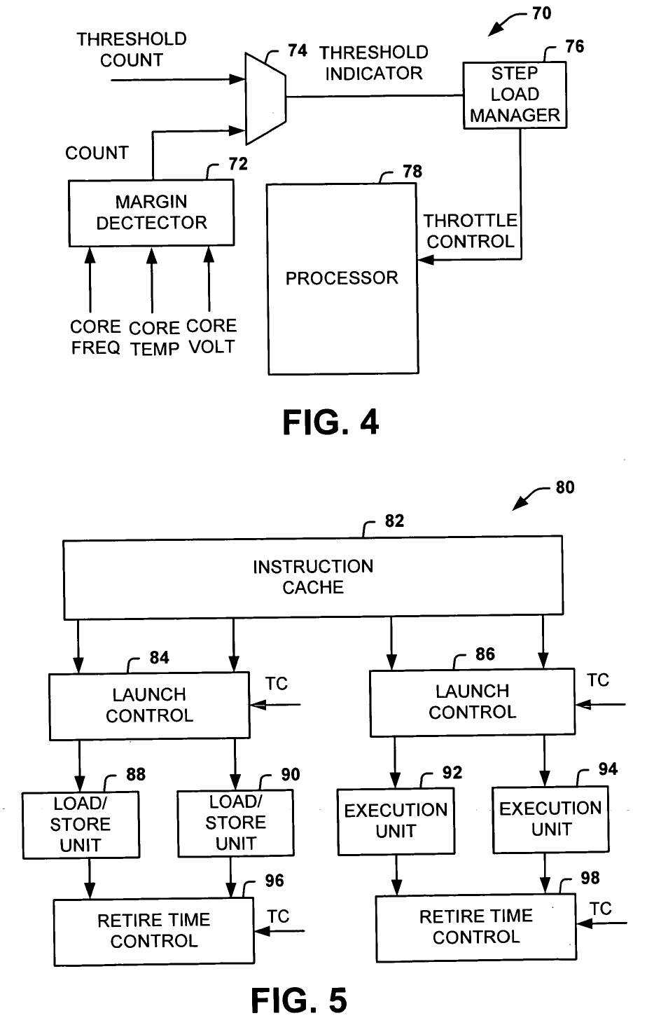

FIG. 4 illustrates a system 70 for maintaining operating conditions below operating condition limits for a processor 78. The system 70 includes a margin detector 72 fabricated on the same silicon chip material as the processor 78, and subject to the same inherent characteristics and operating conditions as the processor 78. The margin detector 72 encodes the voltage, frequency, temperature and age of the processor to generate an aggregated specification count value corresponding to the operating conditions of the processor 78. The aggregated specification count value is compared to a predetermined threshold count value by a comparator 74 to determine if the processor 78 is operating within or outside the operating condition limits of the processor 78. The predetermined threshold count value is set at an operating condition point that is below a maximum specification value associated with maximum allowable operating conditions of the processor 78. The comparator 74 provides a threshold indicator to step load manager 76. The step load manager 76 generates a throttle control signal that instructs the processor 78 to adjust the activity level of the processor 78 to maintain operating conditions within the operating condition limits.

The throttle control signal instructs the processor 78 to one of maintain instruction throughput, increase or step up instruction throughput or decrease or step down instruction throughput. The processor 78 responds by maintaining instruction throughput, stepping down instruction throughput or stepping up instruction throughput. If the specification count value is above the threshold count value and the processor 78 is operating at normal instruction throughput mode, the processor is operating below the operating condition limits of the processor. Therefore, a maintain instruction is provided to the processor 78 for maintaining instruction throughput of the processor 78. If the specification count value is below the threshold count value and the processor 78 is operating at normal instruction throughput mode, the processor 78 is operating outside the operating condition limits of the processor. Therefore, a step down instruction is provided to the processor 78 for reducing instruction throughput of the processor 78. The reduction of instruction throughput cause a reduction in activity of the processor 78 reducing the power dissipation and operating temperature of the processor 78.

For example, if a fault occurs in the cooling system associated with the processor, such as a fan is disabled, the temperature of the processor 78 can increase to a level above the maximum temperature limit unacceptable for proper operation of the processor. Also a sudden increase in the circuit load can cause the voltage of the processor to fall below the minimum allowable voltage limit unacceptable for proper operation of the processor. Therefore, if the processor is executing at four instructions per cycle, the processor can step down to one instruction per four clock cycles in response to a step down instruction to assure that the processor can continue to operate at reduced performance without failing.

If the specification count value is substantially above the threshold count value and the processor 78 is executing at reduced instruction throughput mode, the processor 78 is operating substantially below the operating condition limits of the processor 78. Therefore, a step up instruction is provided to the processor 78 for increasing instruction throughput of the processor 78. The increase of instruction throughput causes an increase in activity of the processor 78 increasing the performance of the processor 78. For example, if a fault in the cooling system is associated with the processor 78 is corrected, such as a fan is re-enabled, the temperature of the processor 78 will decrease to a level well below the maximum temperature limit when the processor 78 is in reduced instruction throughput mode of operation. The processor 78 can increase to allow executing at four instructions per cycle to assure that the processor 78 returns to its normal performance capability.

FIG. 5 illustrates an exemplary instruction throughput portion 80 of a processor. The instruction throughput portion 80 includes a first launch control 84 and a first retire time control 96 associated with a first load/store unit 88 and a second first load/store unit 90. The instruction throughput portion 80 includes a second launch control 86 and a second retire time control 98 associated with a first execution unit 92 and a second execution unit 94. The first and second execution units 92 and 94 can be floating point units, integer units or branch instruction units. The first launch control 84, the first retire time control 96 and the first load/store unit 88 form a first instruction pipeline, and the first launch control 84, the first retire time control 96 and the second load/store 90 form a second instruction pipeline. The second launch control 86, the second retire time control 98 and the first execution unit 92 form a third instruction pipeline, and the second launch control 86, the second retire time control 98 and the second execution unit 94 form a fourth instruction pipeline. Therefore, the instruction throughput portion 80 includes four instruction pipelines and is capable of executing four instructions per clock cycle.

The first and second launch control 84 and 86 can include control associated with fetching instructions from an instruction cache 82, scheduling instructions to be executed, issuing instructions and transferring instructions through an associated pipeline via transfer registers to a given execution unit. One or more of the fetch control, the schedule control, the issue control and transfer control associated with the first and second launch control 84 and 86 can be operative to adjust the instruction throughput through one or more of the respective pipelines based on a throttle control signal (TC) by controlling the launching of instructions through respective pipelines. The first and second retire time control 96 and 98 can include control associated with retiring instruction from an associated pipeline. The first and second retire time control 96 and 98 can be operative to adjust the instruction throughput through one or more of the respective pipelines based on a throttle control signal (TC) by controlling the retiring of instructions from respective pipelines.

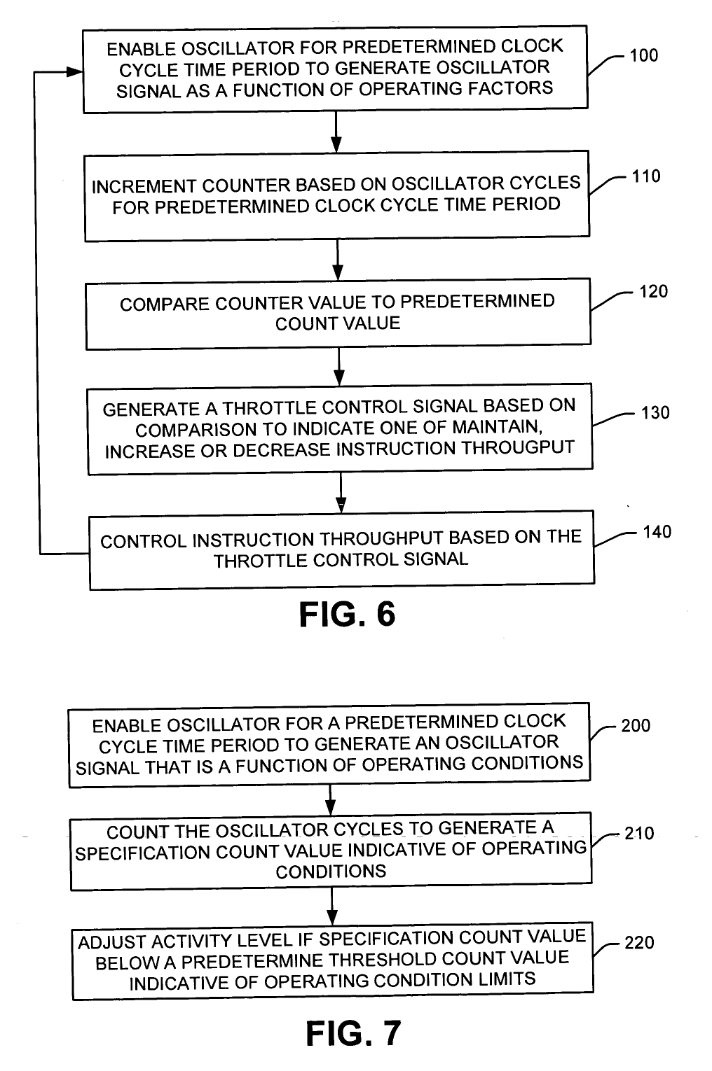

In view of the foregoing structural and functional features described above, certain methods will be better appreciated with reference to FIGS. 6-7. It is to be understood and appreciated that the illustrated actions, in other embodiments, may occur in different orders and/or concurrently with other actions. Moreover, not all illustrated features may be required to implement a method.

FIG. 6 illustrates a methodology for maintaining operating conditions of core circuitry below operating condition limits. At 100, an oscillator is enabled for a predetermined clock cycle time period to generate an encoded oscillator signal that is a function of a plurality of operating factors, such as operating temperature, operating voltage, operating frequency and age of the core circuitry. At 110, a counter is incremented based on the number of oscillator cycles of the oscillator during the predetermined clock cycle time period to provide an aggregated specification count value that corresponds to an aggregated measure of the operating conditions of the core circuitry. At 120, the aggregated specification count value is compared to a predetermined threshold count value to determine if the core circuitry is operating within the operating condition limits of the core circuitry. The predetermined count value is set at an operating condition point that is below a maximum specification value associated with maximum allowable operating conditions of the core circuit. At 130, a throttle control signal is generated based on the comparison to indicate one of maintain, increase or decrease instruction throughput.

For example, if the core circuitry is operating outside the operating condition limits and the processor is operating at normal instruction throughput mode, the threshold control signal instructs the core circuitry to step down or decrease instruction throughput. If the core circuitry is operating within the operating condition limits and the processor is operating at a normal instruction throughput mode, the threshold control signal instructs the core circuitry to maintain instruction throughput. If the core circuitry is operating substantially below the operating condition limits and the processor is operating at reduced instruction throughput mode, the threshold control signal instructs the core circuitry to step up or increase instruction throughput. At 140, instruction throughput is controlled based on the throttle control signal. The methodology then returns to 100 to repeat block 100-140.

FIG. 7 illustrates a methodology for maintaining operating conditions of a core circuit below operating condition limits. At 200, an oscillator is enabled for a predetermined clock cycle time period to generate an oscillator signal that is a function of operating conditions of the core circuit. At 210, the oscillator cycles are counted for the predetermined clock cycle time period to generate a specification count value indicative of the operating conditions of the core circuit. At 220, the activity level of the core circuit is adjusted if the specification count value is below a predetermined threshold count value indicative of the operating condition limits of the core circuit.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system for operating within operating condition limits, the system comprising:
a margin detector that generates a specification value that is a function of a plurality of operating factors associated with a core circuit, and compares the specification value with a predetermined threshold to determine if the core circuit is operating below operating condition limits; and
an operating condition control that adjusts an activity level of the core circuit if the core circuit is operating above operating condition limits.

2. The system of claim 1, wherein the plurality of operating factors comprise core voltage, core frequency, core temperature and core age.

3. The system of claim 1, wherein the operation condition limits and the predetermined threshold value are set at an operating condition point that is below a maximum specification value associated with the maximum allowable operating conditions of the core circuit.

4. The system of claim 1, wherein the core circuitry comprises a processor, and the operating condition control adjusts instruction throughput of the processor if operating conditions of the core circuit exceed operating condition limits.

5. The system of claim 4, wherein the operating condition control reduces the instruction throughput of the processor if operating conditions of the core circuit exceed operating condition limits by reducing one of launch rate and retire rate of instructions.

6. The system of claim 1, wherein the margin detector comprises:
an oscillator that generates an encoded oscillator signal as a function of the core frequency, core voltage and core temperature;
a counter that counts oscillation cycles of the encoded oscillator signal over a predetermined clock cycle time period based on a core frequency associated with a core clock to generate an aggregated specification count value; and
a comparator that compares the aggregated specification count value to a predetermined threshold count value indicative of operating condition limits associated with the core circuitry.

7. The system of claim 6, wherein the comparator generates an overthreshold indicator if the aggregated specification count value is below the predetermined threshold count value.

8. The system of claim 6, wherein the core frequency is encoded in the encoded oscillator signal by enabling the oscillator for the predetermined clock cycle time period, the temperature is encoded in the encoded oscillator signal by subjecting the oscillator to the core temperature and the core voltage is encoded in the encoded oscillator signal by applying the core voltage to circuits associated with the oscillator.

9. The system of claim 6, wherein the oscillator includes a variable delay element that mimics electrical characteristics associated with a critical electrical path of the core circuitry.

10. The system of claim 9, further comprising a plurality of additional oscillators having respective variable delay elements that mimic electrical characteristics associated with different possible critical electrical paths of the core circuitry, wherein the oscillator mimics a critical electrical path of the core circuitry more closely than the plurality of additional oscillators.

11. The system of claim 1, wherein the margin detector is fabricated on a same silicon chip as the core circuitry and subjected to a same operating temperature, a same supply voltage and a same internal frequency as the core circuitry.

12. An integrated circuit comprising:
a processor having an instruction throughput control portion;
a margin detector that generates an aggregated specification count value indicative of operating conditions of the processor; and
a comparator that generates a threshold indicator based on a comparison of the aggregated specification count value and a predetermined threshold count value indicative of operating condition limits of the processor;
wherein the instruction throughput control portion is operative to adjust instruction throughput based on the threshold indicator.

13. The integrated circuit of claim 12, wherein the plurality of operating conditions comprise core voltage, core frequency, core temperature and core age.

14. The integrated circuit of claim 12, wherein the instruction throughput control portion adjusts instruction throughput by adjusting one of launch rate and retire rate of instructions.

15. The integrated circuit of claim 12, further comprising a step load manager that instructs the instruction throughput control to one of maintain, reduce and increase instruction throughput based on the overthreshold indicator.

16. The integrated circuit of claim 12, wherein the instruction throughput control portion reduces instruction throughput if the aggregated specification count value is below the predetermined threshold count value.

17. The integrated circuit of claim 12, wherein the instruction throughput control portion maintains instruction throughput if the aggregated specification count value is above the predetermined threshold count value and the instruction throughput is operating in normal instruction throughput mode.

18. The integrated circuit of claim 12, wherein the instruction throughput control-portion increases instruction throughput if the aggregated specification count value is substantially above the predetermined threshold count value and the instruction throughput is operating in reduced instruction throughput mode.

19. The integrated circuit of claim 12, wherein the margin detector is fabricated on a same silicon chip as the processor, and the margin detector comprises:
an oscillator that generates an encoded oscillator signal as a function of the core frequency, core voltage and core temperature, the oscillator having a variable delay element that mimics a critical electrical path of the processor; and
a counter that counts oscillation cycles of the encoded oscillator signal over a predetermined clock cycle time period based on a core frequency associated with a core clock to generate the aggregated specification count value.

20. The integrated circuit of claim 19, further comprising a plurality of additional oscillators having respective variable delay element that mimic a delay associated with a different possible critical electrical path of the core circuitry, wherein a selected oscillator mimics the critical electrical path of the core circuitry more closely than the plurality of additional oscillators.

21. A system for operating a core circuit within operating condition limits, the system comprising:
means for generating a specification value that is a function of operating frequency, operating voltage and operating temperature of the core circuit;
means for comparing the specification value to a predetermined threshold value indicative of operating condition limits of the core circuit to generate a threshold indicator; and
means for reducing an activity level of the core circuit in response to the threshold indicator indicating that the specification value is below the predetermined threshold value.

22. The system of claim 21, wherein the means for generating a specification value comprises means for generating an oscillator signal that is a function of operating frequency, operating voltage, operating temperature and a delay associated with a critical electrical path of the core voltage.

23. The system of claim 21, wherein the means for generating a specification value further comprises means counting oscillation cycles of the oscillator signal over a predetermined clock cycle time period based on the core operating frequency to generate a specification value count corresponding to the operating conditions of the core circuit.

24. The system of claim 21, wherein the core circuit is a processor and the means for reducing an activity level of the core circuit comprises means for adjusting instruction throughput of the processor.

25. A method for maintaining operating conditions of a core circuit within operating condition limits, the method comprising:
enabling an oscillator for a predetermined clock cycle time period to generate an oscillator signal that is a function of operating conditions of the core circuit;
counting the oscillator cycles for the predetermined clock cycle time period to generate a specification count value indicative of the operating conditions of the core circuit; and
adjusting the activity level of the core circuit if the specification count value is below a predetermined threshold count value indicative of the operating condition limits of the core circuit.

26. The method of claim 25, further comprising comparing the specification count value to the predetermined threshold count value and generating an overthreshold indicator if the specification count value is below the predetermined threshold count value.

27. The method of claim 25, wherein the operating conditions of the core circuit comprise core voltage, core frequency, core temperature and core age.

28. The method of claim 25, wherein the core circuitry comprises a processor, and the adjusting the activity level of the core circuit comprises adjusting instruction throughput of the processor.

29. The method of claim 28, wherein the adjusting the instruction throughput of the processor comprises reducing one of launch rate and retire rate of instructions executed by the processor.

30. The method of claim 25, wherein the oscillator includes a variable delay element that mimics electrical characteristics associated with a critical electrical path of the core circuitry.

31. The method of claim 25, further comprising periodically repeating the enabling, the counting and adjusting.

32. The method of claim 25, wherein the operation condition limits and the predetermined threshold count value are set at an operating condition point that is below a maximum specification value associated with the maximum allowable operating conditions of the core circuitry.
